(19) United States
(12) Patent Application Publication
(10) Pub. No.: US 2022/0339809 A1
(43) Pub. Date: Oct. 27, 2022

(54) RAZOR

(71) Applicant: KAI R&D CENTER CO., LTD., Gifu (JP)

(72) Inventor: Shogo OCHIAI, Gifu (JP)

(21) Appl. No.: 17/762,564

(22) PCT Filed: Oct. 15, 2019
(86) PCT No.: PCT/JP2019/040437

§ 371 Date: Mar. 22, 2022

(30) Foreign Application Priority Data
Oct. 11, 2019 (JP) 2019-188091

(51) Int. Cl. B26B 21/52; A45D 24/02

(52) U.S. Cl. CPC B26B 21/52; A45D 24/02

(57) ABSTRACT

A razor comprises: a head portion, a connecting portion and a gripping portion. The width dimensions of the gripping portion are set to be equal to or greater than the width dimension of the head portion and to increase gradually toward the side leading away from the head portion. The connecting portion linearly connects together both ends of the head portion and both ends of the gripping portion. The height of the connecting portion is set to be smaller than the height dimension of the head portion and the height dimension of the gripping portion. The gripping portion comprises a top surface part, a pair of the side wall parts and rib parts that are slanted in the longitudinal direction, the vertical direction and the width direction. The top surface part, the pair of side wall parts and the rib parts include placement surfaces on which a user's fingers can be placed.

### TECHNICAL FIELD

The invention relates to a rational structuring technique of a razor.

### BACKGROUND TECHNIQUE

A razor structure is known for various aspects of usage. For example, a razor disclosed in Japanese Utility model publication S61-71072 (“patent reference 1”) is known with respect to a razor designed for body hair trimming treatment at a so-called delicate zone including a bikini line and a genital area.

According to the patent reference 1, a technique is disclosed to effectively exclude trimmed under-hairs so as to avoid hindering of the trimming operation.

According to the technique disclosed in the patent reference 1, certain effect can be expected such that the trimmed under-hairs are not accumulated in the vicinity of the blade body and hindering the trimming operation can be avoided. On the other hand, in the delicate zone, not only the improvement of excluding the trimmed body hair, but also further innovative research aiming at improving easiness of the gripping and the operability are also desired.

### Patent Reference 1

Japanese Utility model publication S61-71072

### DISCLOSURE OF THE INVENTION

### Object of the Invention

The invention is made for an object to provide a rational structuring technique of a razor.

### Means for Achieving the Object

Above-explained object is achieved by the invention.

According to the invention, a razor is provided with a grip portion extending in a predetermined longitudinal direction to be served for a gripping of user, a head portion having a blade body and a comb portion provided adjacent to the blade body, the head portion extending in a width direction crossing the longitudinal direction, a connecting portion connecting the grip portion and the head portion.

The blade body of the head portion preferably includes an aspect such that the blade body is entirely disposed over the width direction of the head portion. Otherwise, the blade body of the head portion preferably includes an aspect such that the blade body is partly disposed of the head portion. Further, the “comb portion” is a member which delivers body hairs to be cut to the blade body when the razor is in use. The comb portion effectively prevent the tangling of the body hairs so as not to hinder the hair trimming treatment. In other words, body hairs to be cut are aligned in line by the comb portion which is disposed adjacent to the blade body and then, send to the blade body for the trimming (cutting) treatment.

The width of the grip portion in the width direction is the equal with the width of the head portion in the width direction or more (larger) than the width of the head portion in the width direction entirely in the longitudinal direction. The “equal or more” of the width of the grip portion may include aspects in which the substantially the same width and in which explicitly more than the width of the head portion.

Moreover, the width of the grip portion in the width direction gradually increases in the longitudinal direction as leaving away from the head portion.

“Gradually increase” may typically include an aspect that the width of the grip portion increases “step by step”, “bit by bit” or “sequentially”. This is, it may preferably include any one of the aspects of continuously increase, the aspect of stepwisely increase, and the aspect of partly increase. The “gradually increase” may preferably be provided such that the width of the grip portion increases entirely in the longitudinal direction (except for the rounded region and so on). Further, as to the amount of the increase, it may preferably include the aspect of constant increase of the width of the grip portion (the increase ratio of the width is constant) or the aspect in which the increasing ratio of the width of the grip portion changes. Moreover, “gradually increase as leaving away form the head portion” may typically include the aspect in which the width of the grip portion increases step by step or sequentially, towards the rear side in the longitudinal direction.

By such a construction of the width, precise operation control of the razor, especially of the head portion can be realized. According the known razor, a construction in which the width of the grip portion is smaller than the width of the head portion is generally adopted. In such the known art, the finger force of the user tends to be concentrated to the narrow grip portion and thus, the operation control may tend to be difficult. On the other hand, according to the invention, remarkable improvement is realized.

Further, by the construction of the gradual increase of the width, the width at the front side of the grip portion at which the fingers of the user may touch can be made relatively smaller, while the width at the rear side of the grip portion at which the palm of the user may touch can be relatively larger. As a result, a structure of “gripping tightly and also operating precisely in accordance with the aiming target” can be made so as to secure both ergonomic operability and gripping capability.

Further, the connecting portion respectively linearly connects both the end portions of the head portion with both the end portions of the grip portion in the width direction.

As to the terminology of “linearly connect”, it is typically defined by an aspect such that the one end part of the head portion is connected with the one end part of the grip portion by a minimum distance, while the other end part of the head portion is connected with the other end part of the grip portion by a minimum distance.

By such construction, the size of the grip portion is arranged to be equal or larger than the size of the head portion. Thus, variety of gripping aspects of the grip portion by the user can be realized. And by realizing such variety of gripping aspects, it allows the user to appropriately select the gripping aspect from the abundant types of holding aspects for the body hair trimming (cutting) treatment (operation) for a delicate zone such like a genital region, an armpit region and so on. As a result, precise operation control of the razor can be realized.

Moreover, as the connecting portion respectively linearly connects both ends of the head portion with both ends of the grip portion, the rigidity strength of assembling the head portion with the grip portion can be kept high. Thus, the head portion is prevented from being excessively bent and the durability of the razor can be enhanced.

Further, with respect to the vertical direction crossing both the longitudinal direction and the width direction, the height of the connecting portion is smaller than both the height of the head portion and the height of the grip portion.

By such a construction, when the head portion is conducted to approach to a region difficult to access especially such like a body hair trimming treatment at a delicate zone, the connecting portion with a compact size in the vertical direction (upper-lower direction) can be prevented from being an obstacle for such operation.

Further, for example, by appropriately adjusting the bending strength of the connecting portion, an aspect can be realized in which the relative rotation of the head portion to the grip portion is allowed or prevented.

Moreover, with respect to the vertical direction, each size of the head portion, the connecting portion and the grip portion can appropriately be changed such that an accent is added to the outlook shape of the razor to improve the design taste.

Note that, with respect to the head portion, the connecting portion and the grip portion, these can be an integral forming structure by utilizing resin.

By such a construction, the assembling process of the razor can be rationalized and decreasing of the necessary amount of material can be realized. Moreover, by utilizing the integral forming structure, further taste can be added to the outlook design of the razor.

Further, the grip portion includes a top face portion, a pair of side wall portions extending to cross (typically with the vertical direction) the face direction (both the longitudinal direction and the width direction) of the top face portion from both the end portions of the top face portion in the width direction and a rib connecting the top face portion and the pair of the side wall portions.

By such a construction, the structure of the grip portion can be simplified so as to reduce the necessary materials and enhance the rigidity of the grip portion. Further, by modifying the disposition of the rib portion, further taste can be given to the outlook design of the razor.

Further, the rib is provided obliquely both to the longitudinal direction and the vertical direction.

By such construction, the rib can provide with sufficient strength not only in the width direction but also in the vertical direction. And thus, it can enhance the rigidity and the durability of the razor.

And according to the invention, each of the top face portion, the pair of the side wall portions and the rib is provided with a finger placing face on which the fingers of the user can be placed.

By such a construction, with respect to the holding portion having the width larger than the width of the head portion, the top face portion and each of the side wall portions of the holding portion can be provided with the finger placing face and the user can place the fingers on the finger placing face.

By means of this aspect, in addition to securing the rigidity of the holding portion, the user can utilize relatively broad area for placing the fingers. Thus, the user can have more freedom to appropriately select any suitable one from various aspect of holding styles and the holding capability and the operability of the razor can further be increased.

As a result, the characteristics of this invention as “tight hold and precise operation” can be much more emphasized by the features of “abundant regions for placing the fingers for the holding”.

Note that each of the finger placing face of the top face portion and side wall portions may preferably be provided as continuously on the same plane, and more typically may be provided as a flush surface.

As one of the preferable aspects of the invention, the connecting portion may include a first connecting element and a second connecting element respectively connecting both ends of the head portion and ends of the grip portion in the width direction. And a penetrating opening portion may be formed between the first connecting element and the second connecting element.

By such a construction, the user can directly see the body hair trimming treatment region by the head portion through the penetrating opening portion and thus, the operability can be more enhanced.

With respect to an aspect of increasing the visibility, the penetrating opening portion may preferably be formed entirely over the connecting portion in the longitudinal direction or the width direction.

Further, as one of the preferable aspects of the invention, the comb portion may include a comb portion first component body and a comb portion second component body opposing to the comb portion first component body in the longitudinal direction. The blade body may be clamped between the comb portion first component body and the comb portion second component body.

By such a construction, the body hair to be cut can be securely aligned in use of the razor.

Further, as one of the preferable aspects of the invention, an auxiliary rib may be provided to connect the top face portion and ribs adjacent to each other.

By such a construction, the rib can further be reinforced by the auxiliary rib and the rigidity of the holding portion can be further strengthened. The auxiliary rib may preferably be provided with a finger placing face on which fingers of the user can be placed.

Further, in order for the smoothness of moving fingers, the finger placing face of the auxiliary rib may preferably be provided as on the same plane with the finger placing face of the rib, typically as a flush face. Further, the finger placing face of the auxiliary rib may be on the finger placing faces of the top face portion and the side wall portions, typically as a flush face.

Further, the auxiliary rib may preferably be provided obliquely in the longitudinal direction, width direction and the vertical direction, respectively.

By such a construction, the reinforcing effect to the rib by auxiliary rib can further be enhanced.

Note that the auxiliary rib may preferably be formed as symmetrical and as a pair across the center line in the longitudinal direction. Otherwise, the auxiliary rib may preferably be formed as waving in the longitudinal direction or both. With respect to the outlook design taste, the rigidity and the increase of regions for placing fingers, a plurality of auxiliary ribs can be combined so as to form V-shape or X-shape.

Further, as one of the preferable aspects of the invention, the connecting portion may be provided with a connecting portion rib formed obliquely in the longitudinal direction, width direction and the vertical direction, respectively.

By such a construction, the rigidity of the connecting portion can be more strengthened and the durability of the razor can be increased. Especially, the connecting portion may be provided with a concave portion and the connecting portion rib may be formed in the concave portion.

Note that the connecting rib may be provided with the auxiliary rib or without the auxiliary rib. The connecting rib may preferably be provided with a finger placing face for placing fingers of the user. Further, in order for smooth moving of fingers, the finger placing face of the connecting rib may preferably be provided on the same place with each of the finger placing faces of the grip portion (typically as a flush face).

According to the invention, a rational structuring technique of a razor is provided. [Preferable embodiment for exploiting the invention]

### FIRST EMBODIMENT OF THE INVENTION

First embodiment of the invention is explained according to FIG. 1 to FIG. 11. The first embodiment is related to a razor 1, the entire structure of which is indicated as a projecting view from FIG. 1 to FIG. 5 and as s perspective view in FIG. 6.

The razor 1 is preferably usable for human body's local area such like a genital area including a bikini-line and an I-line, and an armpit area and namely, usable for a body hair trimming treatment at a delicate zone where sensitive operation is required.

### (Basic Structure and Material of the Razor 1)

As shown from FIG. 1 to FIG. 8, the razor 1 according to the embodiment is mainly provided with a head portion 3, a razor holder 2 having a connecting portion 4 and a grip portion 5, and a blade body 37 attached to the razor holder 2.

The head portion 3, the connecting portion 4 and the grip portion 5 are integrally formed by using resin. As the resin material, PP (Polypropylene), as well as ABS, elastomer, PC (Polycarbonate), PET (Polyethylene terephthalate), PVC (Vinyl chloride resin) and so on can preferably be utilized. Note that, in view of the recent trend of plastic reduction, the integral body can be structured by utilizing paper material or cardboard material and so on.

By the integral forming, the manufacturing process of the razor 1 can be rationalized and reduction of the material can be realized. Further, improved design taste can be given to the outlook of the razor 1

On the other hand, the blade body 37 is made as a metal blade. In this embodiment, stainless steel is utilized for the blade body 37. Further, in the embodiment, with respect to the design taste, the head portion 3, the connecting portion 4 and the grip portion 5 are integrally formed by using translucent resin material.

### (Definition of Directions of the Razor 1)

In this embodiment, as shown from FIG. 1 to FIG. 8, the longitudinal direction of connecting the head portion 3, the connecting portion 4 and the grip portion 5 (longitudinal direction of the razor 1, namely front-rear direction) is defined as “LD”. And the direction crossing the LD (Lateral direction of the razor 1, namely right-left direction) is defined as “WD”.

With respect to the longitudinal direction LD, the direction toward the head portion 3 from the connecting portion 4 is defined as “Longitudinal direction front side LDF”. On the other hand, as to the longitudinal direction LD, the rearward of the razor 1, namely the direction toward the grip portion 5 from the connecting portion 4 is defined as “Longitudinal direction rear side LDR”.

Further, the right-left direction of the width direction WD is respectively defined as “Width direction right side WDR” and “Width direction left side WDL”.

Further, the direction both crossing the longitudinal direction LD and the width direction WD is defined as “Upper-lower direction” (height direction of the razor 1). And the side of the grip portion 5 facing to the top face portion 50 is defined as “Upper side TS” and the side of the grip portion 5 opposing to the upper side TS in the upper-lower direction is defined as “Lower side BS”.

### (Structure of the Head Portion 3)

As shown in FIG. 1 and FIG. 6, the head portion 3 includes a head portion first component body 31 integrally formed with the connecting portion 4 and a head portion second component body 33. The head portion second component body 33 is formed separately from the head portion first component body 31 and is connected with the longitudinal direction front side LDF of the head portion first component body 31 such that the blade body 37 is intervened between the head portion first component body 31 and the head portion second component body 33. The head portion second component body 33 is formed by utilizing the same material and the same color with the head portion first component body 31 such that the unity of outlook of the head portion 3 is secured.

Further, as shown in FIG. 6, the head portion first component body 31 and the head portion second component body 33 respectively include a comb portion first component body 32 and a comb portion second component body 34, both of which are combined via a mounting hole 39 as intervening the blade body 37 in the longitudinal direction LD, accordingly a comb portion 35 is provided. The blade body 37 clamped by the head portion first component body 31 and the head portion second component body 33 is disposed such that a blade 38 faces to the lower side BS.

As shown from FIG. 2 to FIG. 4 and in FIG. 6, the comb portion 35 is defined as a member for a combing treatment in order to send body hair to be cut to the blade body 37 when the razor 1 is in use. By the comb portion 35, tangling of the body hair can effectively be avoided so as not to hinder the cutting treatment. Namely, the body hair to be cut is aligned by the comb portion 35 adjacent to the blade body 37 and then sent to the blade body 37 for the cutting treatment.

Note that in this embodiment, the comb portion 35 is formed, with respect to the longitudinal direction LD, as adjacent both to the blade body 37 in the longitudinal direction front side LDF and in the longitudinal direction rear side LDR. On the other hand, the comb portion 35 may be formed as adjacent to the blade body 37 only one of the longitudinal direction front side LDF and in the longitudinal direction rear side LDR.

In this embodiment, the disposition pitch of each comb of the comb portion 35 is approximately 1.0 mm (millimeter) and 17 combs in total are assembled to form the comb portion 35.

### (Structure of the Connecting Portion 4)

As shown in FIG. 2, FIG. 3 and FIG. 6, the connecting portion 4 includes a first connecting element 41 and a second connecting element 42.

A penetrating opening portion 43 is formed between the first connecting element 41 and the second connecting element 42 as facing both the upper face TS and the lower face BS. The penetrating opening portion 43 is arranged to have an opening width OW corresponding approximately to 60% of the head portion 3 in the width direction WD, such that the comb portion 35 and the blade portion 37 are directly visible from the upper face TS through the penetrating opening portion 43.

### (Structure of the Grip Portion 5)

As shown from FIG. 1 to FIG. 3, in FIG. 7 as is the cross-sectional view at A-A line in FIG. 2 and in FIG. 8 as is the cross-sectional view at B-B line in FIG. 2, the grip portion 5 is formed to extend in the longitudinal direction LD. The grip portion 5 is mainly provided with a top face portion 50, a first side wall portion 51, a second side wall portion 52, a front face portion 53 and a rear face portion 54. The first side wall portion 51 and the second side wall portion 52 are formed to extend, with respect to the width direction WD, from both ends of the top face portion 50 in the direction crossing the face direction of the top face portion 50, namely in the vertical direction VD. Further, a bottom face side opening portion 55 is formed at the bottom face side BS of the grip portion 5.

### (Structure of the Rib 57)

As shown in FIG. 3, FIG. 7 and in FIG. 8, the grip portion 5 is formed in a hollow shape. At the hollow shaped region, a plurality of ribs 57 are formed at even intervals in the longitudinal direction LD such that the rib 57 integrally connects the first side wall portion 51, the second side wall portion 52 and the top face portion 50. The rib 57 is an example of “rib portion” according to the invention.

In this embodiment, each of ribs 57 is disposed at even intervals of approximately 12 mm (millimeter).

The rib 57 is integrally formed with the head portion 3, connecting portion 4 and the grip portion 5 by utilizing a resin.

Further, as shown in FIG. 2, FIG. 3 and FIG. 7, the rib 57 is disposed obliquely both to the longitudinal direction LD and the vertical direction VD. As a result, rigidity strength in multiple directions can be enhanced

### (Each Part of the Grip Portion Forms the Finger Placing Face 59)

Each of the top face portion 50, the first side wall portion 51, the second side wall portion 52, the front face portion 53, the rear face portion 54 and the rib 57 is respectively provided with a finger placing face 59.

And the finger placing face 59 of each element is respectively connected to each other to be on the same place (flush). Thereby, when the user grips the grip portion 5 to move fingers on the grip portion 5, unnecessary resistance may not occur and smooth moving action can be secured.

### (Characteristic of the Width)

As shown in FIG. 2 and FIG. 3, the width of the grip portion 5 in the width direction (hereinafter referred to as “HLW”) is equal to or more (larger) than the width HW of the head portion 3 in the width direction at everywhere in the longitudinal direction from the width HLW1 at the minimum region (connecting portion adjacent region) to the width HLW2 at the maximum region. Moreover, the width HLW of the grip portion 5 in the longitudinal direction LD gradually increases as leaving away from the head portion 3 (namely leaving in the longitudinal direction rear side LDR)

In this embodiment, the minimum width HLW1 of the grip portion 5 is approximately 25 mm (millimeter), the maximum width of the grip portion 5 is approximately 28 mm (millimeter) and the width HW of the head portion 3 is approximately 23 mm (millimeter).

### (Connecting Aspect of the Connecting Portion 4)

As shown in FIG. 2, the connecting portion 4 linearly connects both ends 3L, 3R of the head portion 3 in the width direction WD and both ends 5L, 5R of the grip portion 5 in the width direction WD.

In other words, it is arranged to connect both ends 3L, 3R of the head portion 3 in the width direction WD and both ends 5L, 5R of the grip portion 5 in the width direction WD by the shortest distance.

By such construction, the size of the grip portion 5 is arranged to be equal to or more (larger) than the size of the head portion 3 and then, gripping aspect of the grip portion 5 by the user can be diversified (this aspect will be explained later by using from FIG. 9 to FIG. 11). By diversifying the gripping aspect, the user can appropriately select one of the various gripping types during the body hair trimming (cutting) treatment at the delicate zone such like a genital are or an armpit area. As a result, precise operation control of the razor 1 can be realized.

Moreover, by the above-explained gradual increase structure of the width, the width of the grip portion 5 at the longitudinal direction front side LDF on which fingers of the user may touch is made relatively smaller, while the width of the grip portion 5 at the longitudinal direction rear side LDR on which palm of the user may touch is made relatively larger. Thus, standing on the ergonomic aspects, both of gripping with certain amount of gripping strength and precise and accurate operation can be secured.

Further, the connecting portion 4 linearly connects both ends 3L, 3R of the head portion 3 with both ends 5L, 5R of the grip portion 5 and as a result, the assembling rigidity of the head portion 3 and the grip portion 5 can be kept high and thus, durability of the razor 1 can be enhanced.

### (Characteristic in the Upper-Lower Direction)

As shown in FIG. 7, in this embodiment, the height of the first connecting element 41 and the second connecting element 42, namely the connecting portion height CH is arranged to be smaller than the height of the head portion 3 (namely “head portion height HH”) and the height of the grip portion 5 (namely “grip portion height HLH”).

Specifically, the head portion height HH is approximately 11 mm (millimeter), the connecting portion height CH is approximately 4 mm (millimeter) and the grip portion height HLH is approximately 13 mm (millimeter).

Note that, in this embodiment, due to mainly design taste control, the head portion 3, the connecting portion 4 and the grip portion 5 are rounded, the size of which are gradually increased or decreased. Therefore, each height of elements are explained by using each maximum (or minimum) size.

By such construction, when the head portion 3 (blade body 37) approaches to a region with difficult accessibility especially in body hair trimming operation at the delicate zone, the connecting portion 4 with compact size in the vertical direction VD does not hinder the operation.

Further, by appropriately adjusting the bending rigidity of the connecting portion 4, allowance and prohibition of the relative rotation of the head portion 3 to the grip portion 5 can be controlled.

Further, by appropriately changing the size of the head portion 3, connecting portion 4 and the grip portion 5, an accent can be added to the outlook of the razor 1 so as to improve the design taste.

Moreover, due to the characteristic regarding the vertical direction, the connecting concave portion 45 formed at the side of the lower face BS of the connecting portion 4 can be used for user's grip.

### (First Gripping Aspect: Gripping in the Vertical Direction)

Next, three typical examples regarding the gripping aspects of the razor 1 (razor holder 2) according to the embodiment are explained.

First grip aspect is shown in FIG. 9. In this aspect, the grip operation is done by utilizing the finger placing face 59 at the top face portion 50 and the rib 57 of the grip portion 5. Specifically, the index finger (second finger) F2 and the middle finger (third finger) F3 of user's fingers F are placed on the finger placing face 59 of the top face portion 50 and thumb (first finger) F1 is placed on the finger placing face 59 of the rib 57. Thus, the user can grip the grip portion 5 and then, operate the head portion 3 at the treatment region. As explained above, in this embodiment, due to the characteristic of the width and the height of the grip portion 5, accurate operation control at the delicate zone can be easily done.

### (Second Gripping Aspect: Side Gripping)

Second grip aspect is shown in FIG. 10. In this aspect, the grip operation is done by utilizing the finger placing face 59 at the first said wall portion 51 and the second side wall portion 52 of the grip portion 5.

Specifically, the thumb (first finger) F1 and the index finger (second finger) of user's fingers F are respectively placed on the finger placing face 59 of the first side wall portion 51 and the second side wall portion 52 to hold the grip portion 5. Then, the user operates the head portion 3 at the treatment region.

As explained above, in this embodiment, due to the characteristic that the comb portion 35 (and the blade body 37) is directly visible through the penetrating opening portion 43, working efficiency is further enhanced.

### (Third Gripping Aspect: Reverse Gripping)

Third grip aspect is shown in FIG. 11. In this aspect, as the same with the first grip aspect, the grip operation is done by utilizing the finger placing face 59 at the top face portion 50 and the rib 57 of the grip portion 5.

Specifically, while the thumb F1 is placed on the finger placing face 59 of the rib 57 by crossing with the grip portion 5, the index finger F2 (or the middle finger F3 or the ring finger F4) is placed on the finger placing face 59 of the top face portion 50 in a crossing manner. Thus, the user can reversely grip the grip portion 5 and then, operate the head portion 3 at the treatment region.

Also in the third embodiment, due to the characteristic of the width and the height of the grip portion 5, accurate operation control at the delicate zone can be easily done.

While in this embodiment, three types of gripping aspects are explained as typical examples, other gripping aspect by the user can also be adapted. For example, the razor 1 can be operated by inserting fingers into the penetrating opening portion 43 as shown in FIG. 2, FIG. 3 and FIG. 6, and then, by placing fingers on the finger placing face 59 provided at the front face portion 53.

Otherwise, the razor 1 can be operated by placing fingers on the finger placing face 59 provided on the rear face portion 54 as shown in FIG. 2, FIG. 3 and FIG. 5.

### (Product Design of the Razor 1 According to the Embodiment)

The product design of the razor 1 according to the embodiment is shown in FIG. 12 as six projection views (the back vies is the same with the front view and is abbreviated).

### SECOND EMBODIMENT OF THE INVENTION

Next, in reference to FIG. 13 to FIG. 15, second embodiment of the invention is explained. The second embodiment comprises substantially the same construction with the above-explained first embodiment as to the basic structure. On the other hand, the second embodiment additionally includes auxiliary rib to the rib 57 (FIG. 3 and so on should be referred). Therefore, substantially the same structure with the first embodiment is not explained and is not shown in the drawings.

### (Entire Structure of the Second Embodiment)

FIG. 13 shows the entire structure of the razor 101 according to the second embodiment as six projection views. Note that the back view is the same with the front view and is abbreviated.

As shown in FIG. 13, the razor holder 102 of the razor 101 is integrally formed by utilizing a translucent resin with respect to a head portion 103, connecting portion 104 and a grip portion 105. As the resin material, as the same with the first embodiment, PP (Polypropylene), as well as ABS, elastomer, PC (Polycarbonate), PET (Polyethylene terephthalate), PVC (Vinyl chloride resin) and so on can preferably be utilized. In order to increase the distinguishability and design taste, the resin material may preferably be arbitrarily colored.

Further, as different from the first embodiment, the comb portion second component body 134 is formed to entirely extend over the head portion 103 in the vertical direction so as to increase the design taste.

### (Structure of the Auxiliary Rib 161)

As one of the characteristic structures of the second embodiment, as shown in the bottom view of FIG. 13, the razor 101 is provided further with an auxiliary rib 161 attached to the rib 156 having the same construction with the one in the first embodiment. The auxiliary rib 161 is an example corresponding to the “auxiliary rib” according to the invention.

The auxiliary rib 161 is integrally formed with other component members by utilizing the resin material forming the razor holder 102. The auxiliary rib 161 integrally connects the rib 157-157 adjacent to each other and the top face portion 150 of the grip portion 105.

As shown in FIG. 14 which is an enlarged bottom view of the razor 101, the auxiliary rib 161 is formed to cross the longitudinal direction LD and the width direction WD, and to cross the vertical direction VD in FIG. 15 which is a cross sectional view at C-C line of razor 101. In FIG. 14 and FIG. 15, in order to avoid complication, numerical references are only partly indicated without indicating all.

Further, the auxiliary rib 161 is formed symmetrically and in pair across the central line in the longitudinal direction LD so as to extend in the longitudinal direction LD in a wave-manner. As a result, the auxiliary rib 161 appears V-shapes or X-shapes in series in the bottom view of FIG. 13 and in FIG. 14.

The auxiliary rib 161 is formed to cross, to be symmetrical and waved and thus, reinforced structure can be provided entirely over the grip portion 105 in a dense manner and rigidity strength of the grip portion 105 can entirely be increased over the grip portion 105 without decreasing regions where the rigidity strength decreases as much as possible. Further, by such disposition of the auxiliary rib 161, an accent can be added to the outlook design of the grip portion 105 and the razor 101 so as to increase the design taste.

### (Finger Placing Face 163 of the Auxiliary Rib 161)

Further, as shown in FIG. 14 and FIG. 15, the region of the auxiliary rib 161 facing the bottom side opening portion 155 is provided with a finger placing face 163. The finger placing face 163 is an example of “auxiliary rib finger placing face” according to the invention.

The finger placing face 163 of the auxiliary rib 161 is on the same plane (flush) with the finger placing face 159 of the rib 157.

As a result, as is the same with the first embodiment, each of the top face portion 150, the first side wall portion 151, the second side wall portion 152, the front face portion 153, the rear face portion 154 and the rib 157 includes finger placing face 159. Further, the auxiliary rib 161 includes a finger placing face 163 and respective finger placing faces 159, 163 are continuously connected to each other to be on the same plane (flush) with each other.

Accordingly, when the user grips the grip portion 105 to move fingers on the grip portion 105, unnecessary resistance may not occur and smooth moving action can be secured.

As explained above, according to the second embodiment, the auxiliary rib 161 is formed to cross, to be symmetrical and waved and the auxiliary rib 161 is provided entirely over the grip portion 105 in a dense manner. Thus, the finger placing face 163 for placing fingers in use can be entirely evenly disposed over the grip portion 105 and freedom of selection as to where fingers should be placed is drastically increased.

Further, the finger placing face 163 of the auxiliary rib 161 and the finger placing face 159 of the rib 157 are on the same plane and therefore, when the user moves the placed fingers across the rib 157 over the auxiliary rib 161, unnecessary resistance may not occur and smooth moving action can be secured.

### (Structure of the Connecting Portion Rib 173)

Further, according to the second embodiment, as especially shown in FIG. 14 (and in FIG. 15), at the space of the connecting portion 104 adjacent to the grip portion 105, namely at the grip portion adjacent region 107, a concave portion 171 in an open style is formed. The concave portion 171 is provided with a connecting portion rib 173. The connecting portion rib 173 is an example corresponding to the “connecting portion rib” according to the invention.

The connecting portion rib 173 is provided to extend to respectively cross the longitudinal direction LD, width direction and the vertical direction VD, as well as the auxiliary rib 161. Further, as shown in FIG. 14 and FIG. 15, a finger placing face 175 is provided at the lower face side BS of the connecting portion rib 173. The finger placing face 175 is an example corresponding to the “connecting portion rib finger placing face” according to the invention.

Further, the finger placing face 175 is provided to be on the same plane (to be flush) with each of the finger placing face 159 of the grip portion 105 (the finger placing face 163 of the auxiliary rib 161).

Therefore, places for putting fingers not only on the grip portion 105 but also on the connecting portion 104 are realized. Thus, freedom for the user in selecting the gripping place is increased and then, the usage and the operability of the razor 101 are improved.

According to each of above-explained embodiments, techniques to improve the gripping and operability of the razor 1, 101 for the user are provided.

### BRIEF EXPLANATION OF THE DRAWINGS

FIG. 1 is a front view showing the entire structure of the razor 1 according to the embodiment of the invention.

FIG. 2 is a plane view showing the entire structure of the razor 1 according to the embodiment of the invention.

FIG. 3 is a bottom view showing the entire structure of the razor 1 according to the embodiment of the invention.

FIG. 4 is a left side view showing the entire structure of the razor 1 according to the embodiment of the invention.

FIG. 5 is a right side view showing the entire structure of the razor 1 according to the embodiment of the invention.

FIG. 6 is a partly exploded perspective view showing the entire structure of the razor 1 according to the embodiment of the invention.

FIG. 7 is a cross sectional view at A-A line in FIG. 2.

FIG. 8 is a cross sectional view at B-B line in FIG. 2.

FIG. 9 is a schematic view showing the first aspect of usage of the razor 1 according to the embodiment of the invention.

FIG. 10 is a schematic view showing the second aspect of usage of the razor 1 according to the embodiment of the invention.

FIG. 11 is a schematic view showing the third aspect of usage of the razor 1 according to the embodiment of the invention.

FIG. 12 is a projection view showing the product design of the razor 1 according to the embodiment of the invention.

FIG. 13 is a projection view showing the razor 101 according to the second embodiment of the invention.

FIG. 14 is a bottom view showing the razor 101 according to the second embodiment of the invention.

FIG. 15 is a cross sectional view at C-C line of FIG. 14.

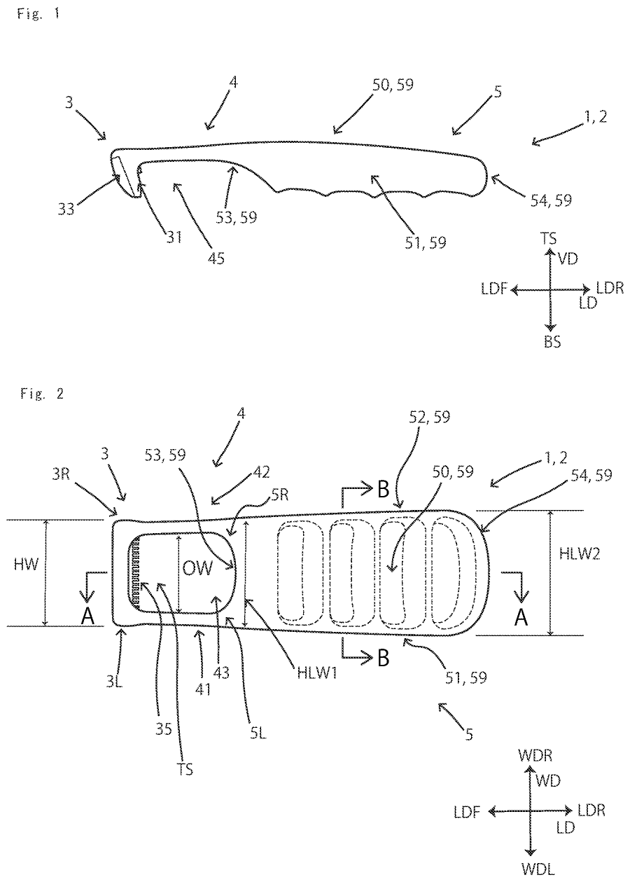

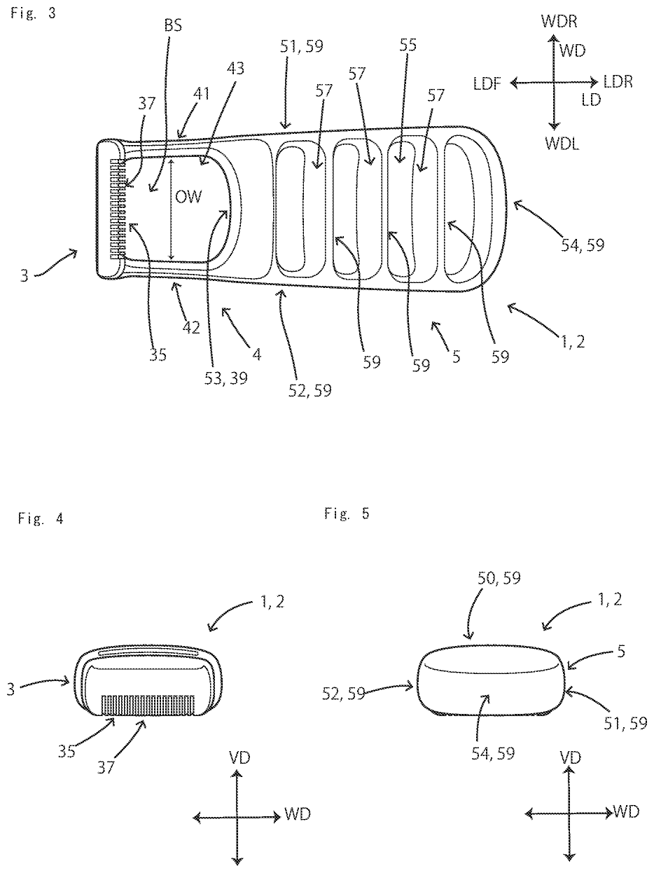

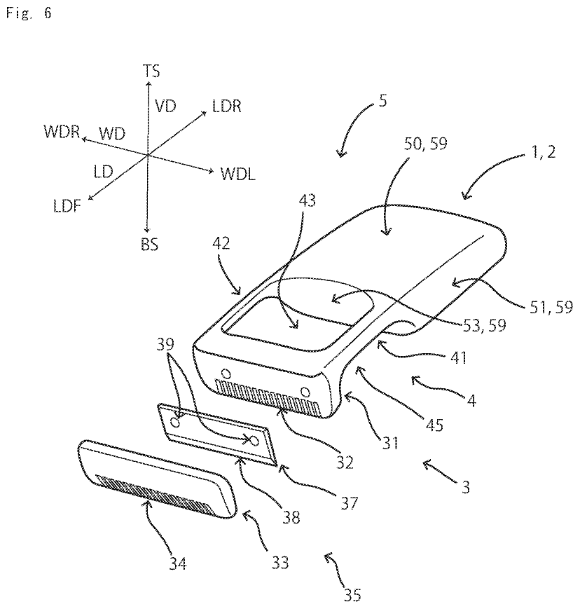

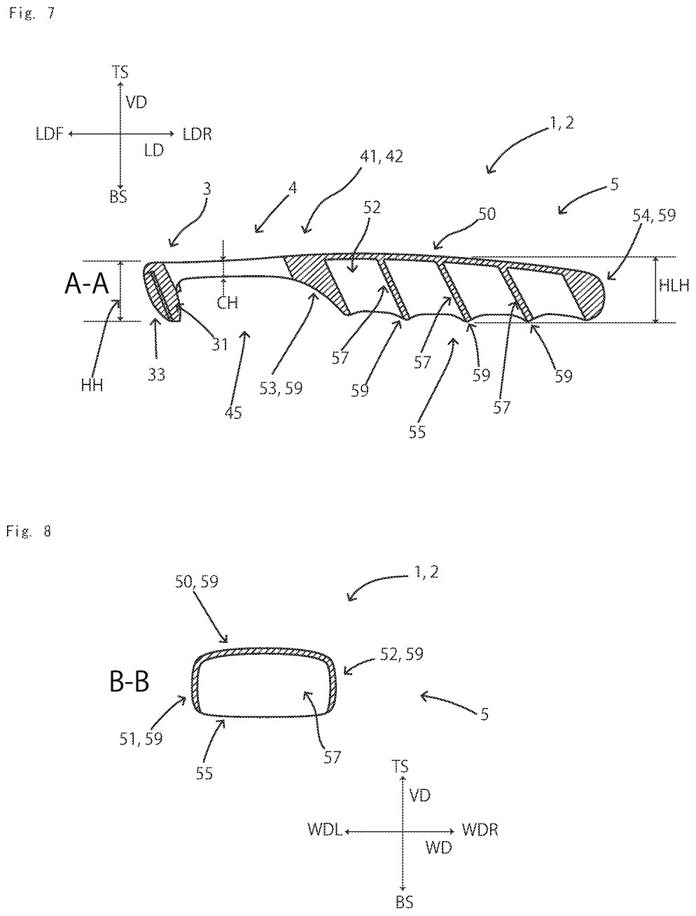

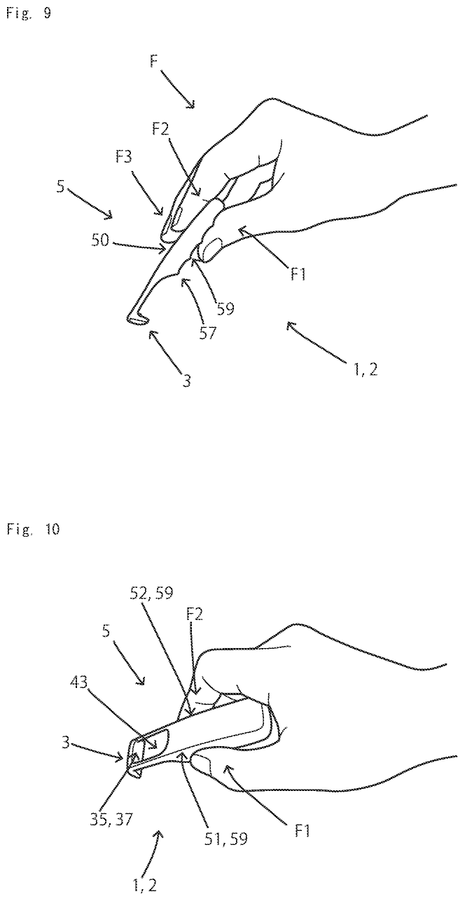

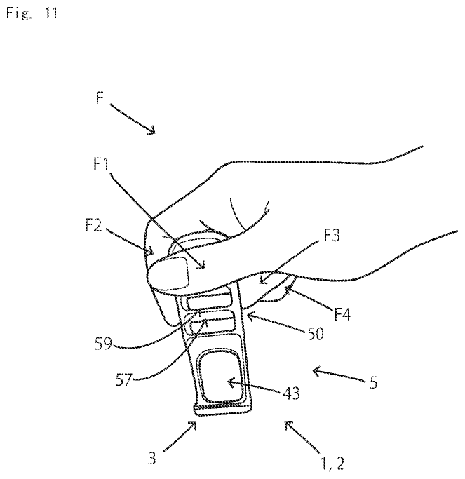

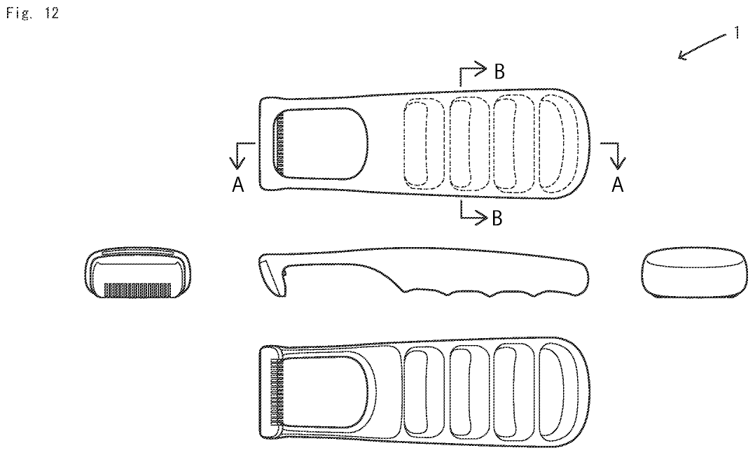

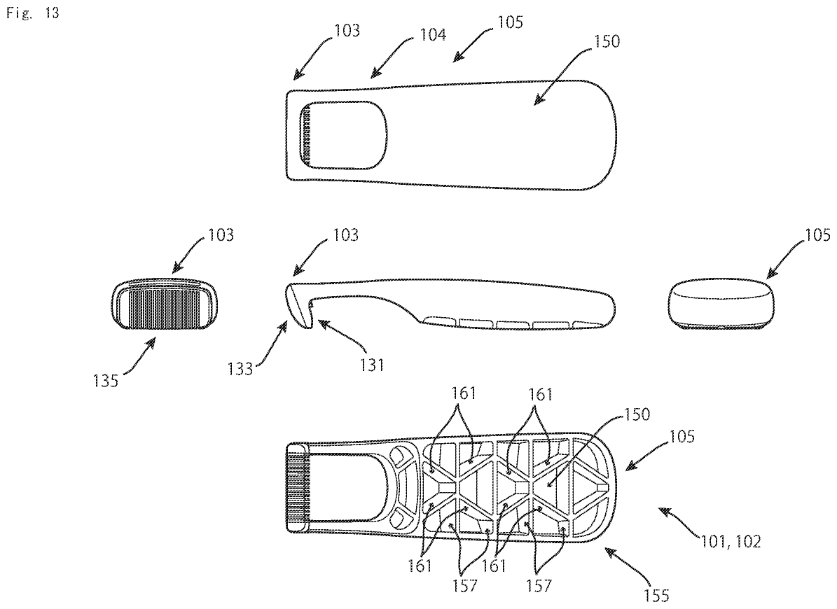

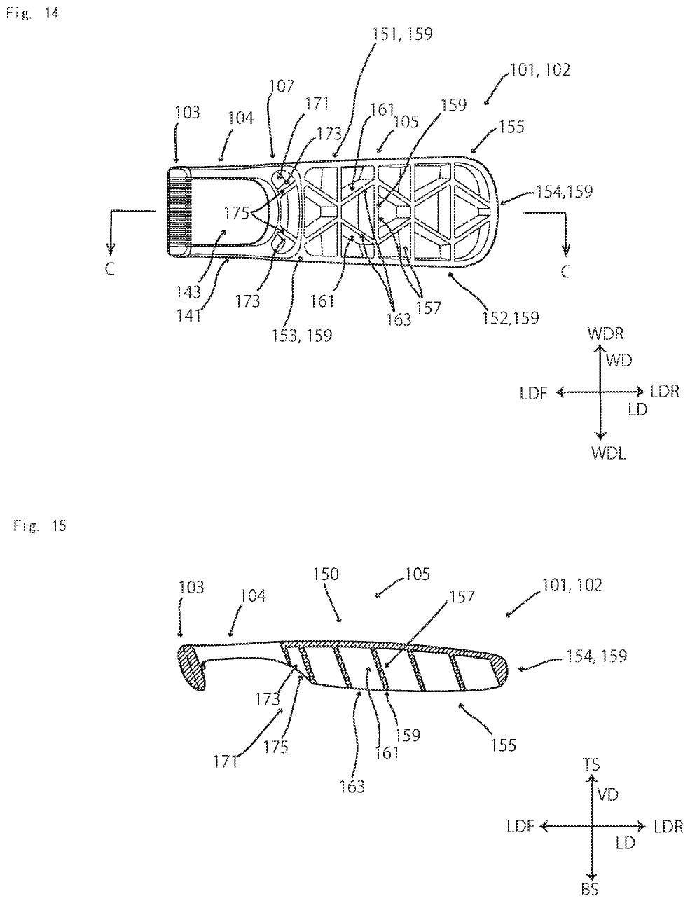

### EXPLANATION OF THE REFERENCES

1: Razor, 2: Razor holder, 3: Head portion, 31: Head portion first component body,
32: Comb portion first component body, 33: Head portion second component body,
34: Comb portion second component body, 35: Comb portion, 37: Blade body, 38: Blade, 39: Mounting hole,
4: Connecting portion, 41: First connecting element, 42: Second connecting element,
43: Penetrating opening portion,
5: Grip portion
50: Top face portion, 51: First side wall portion, 52: Second side wall portion,
54: Rear face portion, 55: Bottom face side opening portion, 57: Rib,
59: Finger placing face,
101: Razor, 102: Razor holder, 103: Head portion, 104: Connecting portion, 105: Grip portion, 107: Grip portion adjacent region, 150: Top face portion, 151: First side wall portion, 152: Second side wall portion, 153: Front face portion, 154: Rear face portion,
155: Bottom face side opening portion, 157: Rib, 159: Finger placing face,
161: Auxiliary rib, 163: Auxiliary rib finger placing face, 171: Concave portion, 173: Connecting portion rib, 175: Connecting portion rib finger placing face,
LD: Longitudinal direction, WD: Width direction, VD: Vertical direction,
TS: Upper face, BS: Lower face, HW: Head portion height,
CW: Connecting portion width, CH: Connecting portion height,
HLW (1,2): Grip portion width, HLH: Grip portion height,
F: Fingers
F1: Thumb (First finger), F2: Index finger (Second Finger),
F3: Middle finger (Third finger), F4: Ring finger (Fourth finger)

1. A razor comprising:
a grip portion extending in a predetermined longitudinal direction to be served for a gripping of user,
a head portion having a blade body and a comb portion provided adjacent to the blade body, the head portion extending in a width direction crossing the longitudinal direction,
a connecting portion connecting the grip portion and the head portion,
wherein the width of the grip portion in the width direction is the equal or more than the width of the head portion in the width direction entirely in the longitudinal direction and
the width of the grip portion in the width direction gradually increases in the longitudinal direction as leaving away from the head portion,
the connecting portion respectively linearly connects both the end portions of the head portion with both the end portions of the grip portion in the width direction,
with respect to the vertical direction crossing both the longitudinal direction and the width direction, the height of the connecting portion is smaller than both the height of the head portion and the height of the grip portion,
the grip portion includes a top face portion, a pair of side wall portions extending to cross the face direction of the top face portion from both the end portions of the top face portion in the width direction and a rib connecting the top face portion and the pair of the side wall portions,
the rib is provided obliquely both to the longitudinal direction and the vertical direction,
each of the top face portion, the pair of the side wall portions and the rib is provided with a finger placing face on which the fingers of the user can be placed.

2. The razor according to claim 1, wherein the connecting portion includes a first connecting element and a second connecting element respectively connecting both ends of the head portion and ends of the grip portion in the width direction and
a penetrating opening portion is formed between the first connecting element and the second connecting element.

3. The razor according to claim 1, wherein the comb portion includes a comb portion first component body and a comb portion second component body opposing to the comb portion first component body in the longitudinal direction and
the blade body is clamped between the comb portion first component body and the comb portion second component body.

4. The razor according to claim 1, wherein an auxiliary rib is provided to connect the top face portion and ribs adjacent to each other.

5. The razor according to claim 4, wherein the auxiliary rib is provided obliquely to the longitudinal direction, width direction and the vertical direction, respectively.

6. The razor according to claim 4, wherein the auxiliary rib is provided with an auxiliary rib finger placing face such that the auxiliary rib finger placing face is on the same plane with the finger placing face.

7. The razor according to claim 1, wherein the connecting portion is provided with a concave portion at the region adjacent to the grip portion and
a connecting portion rib is provided in the concave portion obliquely to the longitudinal direction, width direction and the vertical direction, respectively.

8. The razor according to claim 7, wherein the connecting portion rib is provided with a connecting portion rib finger placing face on the same plane with the finger placing face.
